(19) United States
(12) Patent Application Publication
(10) Pub. No.: US 2022/0127452 A1
(43) Pub. Date: Apr. 28, 2022

(54) ORGANIC COMPOSITE MATERIAL AND A METHOD FOR MANUFACTURING THE SAME

(71) Applicant: WAYFORM, LLC, Sarasota, FL (US)

(72) Inventor: Tyler EVANS, Frisco, TX (US)

(73) Assignee: WAYFORM, LLC, Sarasota, FL (US)

(21) Appl. No.: 17/076,829

(22) Filed: Oct. 22, 2020

(51) Int. Cl. C08L 67/04; B29B 7/90; C08J 3/20; C08L 3/02

(52) U.S. Cl. CPC C08L 67/04; B29B 7/90; B29K 2067/00; C08L 3/02; C08J 3/201

(57) ABSTRACT

The present disclosure describes a composite material and a method for making the composite material. The method includes mixing a copolymer binder with a thermoplastic biopolyester polymer (TBP) at a mixing temperature of 80-280° C. to create a polymer mixture; and mixing pyrolysized organic matter and an organic filler material with the polymer mixture to create the composite material. In an embodiment, the source of the pyrolysized organic matter is post-consumer food waste, and the mixing is performed by a shear mixer that is operated at 40-100 revolutions per minute (RPM). The composite material may comprise by weight at least 35% of a combination of the pyrolysized organic matter and the organic filler material.

### TECHNICAL FIELD

The present invention relates generally to an organic composite material, and more specifically to a post-consumer waste-based composite material and a method of manufacturing the same.

### BACKGROUND

Food waste is a growing problem internationally, where a significant percentage of consumer food product is discarded into landfills. Because exposure to environmental factors is limited in a tightly packed mound of waste, the natural decomposition process of the food is significantly slowed down. Further, decomposition of organic material in the absence of air, known as the anaerobic process, results in a significant release of methane gas, a greenhouse gas that is twenty times more effective at trapping heat than carbon dioxide.

In an effort to reduce waste and harmful environmental effects and produce material from recycled matter, various types of plastics that incorporate waste material have been suggested. These include disposable, or single-use, materials that are composed of recovered matter, including post-consumer waste. To increase the biodegradability of these materials, organic matter is added to encourage decomposition, including organic matter from food waste.

However, the materials produced by current solutions have a number of undesirable qualities. Known methods of manufacturing waste-based materials that use organic components often produce a material that is insufficiently biodegradable, exhibits a low melting point, and produces undesirable mechanical properties, such as having a low percentage elongation and low tensile strength. Additionally, the challenge of uniformly integrating the organic material within the final product often produces a rough texture that can be undesirable for certain uses, such as consumer packaging. Furthermore, many of the current methods of creating recycled material are only capable of incorporating a minimal amount of post-consumer organic waste due to limited integration allowed by the current solutions, thus reducing the overall amount of organic material that can be recycled.

One method of integrating organic matter within recycled material is through pyrolysis, a process involving the heating of organic matter in the absence or near absence of oxygen, which produces various byproducts, including biochar. Biochar is an output of the pyrolysis process when agricultural waste, including biomass and crop waste, is used a source material. However, current methods of pyrolysis used in the creation of recycled materials focus on biomass-based biochar rather than post-consumer food waste-based pyrolysized organic matter. The current processes used for the integration of organic matter into a polyester copolymer includes mixing the pyrolysized organic matter directly with a thermoplastic biopolyester polymer (TBP). Such processes fail to create a homogenous mixture and zones of immiscible material remain throughout the composite, causing uneven surfaces and structure that may ultimately result in material failure.

Accordingly, an improved post-consumer waste based composite material and method for manufacturing the same is desirable.

### SUMMARY

A method for manufacturing a composite material includes mixing a copolymer binder with a thermoplastic biopolyester polymer (TBP) at a mixing temperature of 80-280° C. to create a polymer mixture, and mixing pyrolysized organic matter and an organic filler material into the polymer mixture to create the resulting organic composite material. In an embodiment, the mixing is performed by a shear mixer that is operated at 40-100 revolutions per minute (RPM).

In an embodiment, the method includes combining the pyrolysized organic matter and the organic filler material to create an organic mixture, and mixing the organic mixture with the polymer mixture to create the composite material.

In an embodiment, the pyrolsized organic matter may include post-consumer waste material, such as food waste. The organic filler material may be an organic material with a particle size of 1-10 micrometers.

A composite material produced from this method includes a material comprising a copolymer binder, a thermoplastic biopolyester polymer (TBP), pyrolysized organic matter; and an organic filler material. In an embodiment, the composite material comprises by weight at least 50% of a combination of the pyrolysized organic matter and the organic filler material.

The aforementioned embodiments and other advantages of the embodiments described herein will be apparent to those of ordinary skill in the art at least by reference to this summary, the following detailed description, and the accompanying drawings.

### BRIEF DESCRIPTION OF THE DRAWINGS

The systems and methods described herein may be better understood with reference to the following drawings and detailed description. Non-limiting and non-exhaustive embodiments are described with reference to the following drawings.

FIG. 1 is a flowchart of a method for manufacturing a composite material in accordance with an embodiment of the present disclosure;

FIG. 2 is a schematic diagram of the manufacturing process of the composite material in accordance with the method of FIG. 1;

FIG. 3 is a flowchart of a method for manufacturing a composite material in accordance with an additional embodiment of the present disclosure;

FIG. 4 is a schematic diagram of the manufacturing process of the composite material in accordance with the method of FIG. 3; and

FIG. 5 is a microscopic image of a surface of pyrolysized organic matter in accordance with embodiments of the present disclosure.

### DETAILED DESCRIPTION

The present disclosure provides a composite material and a method of manufacturing the same. The disclosed composite material comprises a copolymer binder, a thermoplastic biopolyester polymer (TBP), pyrolysized organic matter, and an organic filler material.

The use of a compatibilizer introduced at a particular stage in the manufacturing process overcomes the shortcomings of the prior art. The compatibilizer is an ingredient that promotes interfacial adhesion between pairs of polymers that are otherwise immiscible. Elements of the compatibilizer are able to interact with the ingredient materials of the composite material to stabilize the phase morphology of the composite. This increase in phase morphology stabilization is caused by a reduction in particle size of the phase superfeed particles in the blend, e.g., of the TBP, the organic filler material, and the pyrolysized organic matter. This allows for immiscible blends to break up into smaller particle series during a melting/sheering/mixing phase.

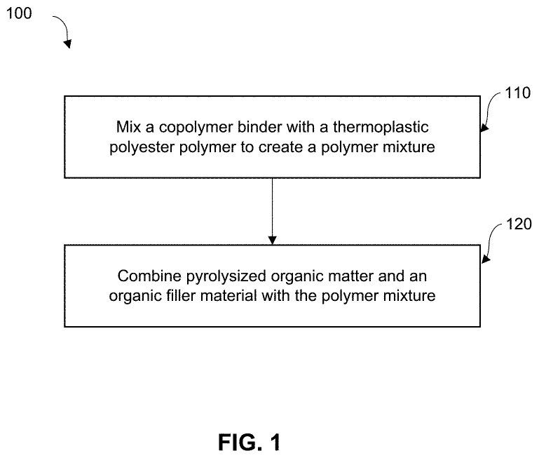

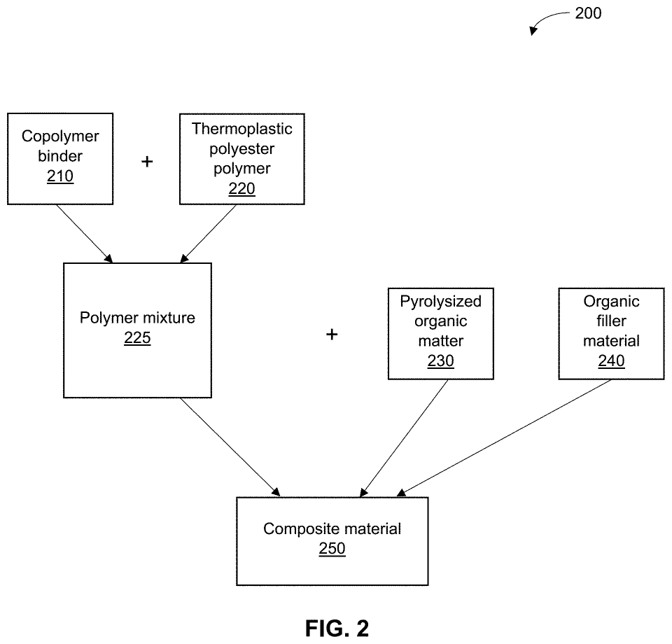

FIG. 1 is a flowchart of a method 100 for producing a composite material, and will be described in conjunction with FIG. 2, which is a schematic diagram 200 of the manufacturing process of the composite material in accordance with the method of FIG. 1.

At step 110, a copolymer binder 210 is mixed with a thermoplastic biopolyester polymer (TBP) 220 to create a polymer mixture 225.

The copolymer binder 210 may be polyvinyl acetate (PVA), ethylene, or similar binders for bonding and coating different materials. PVA may be characterized as a compatibilizer, as its presence in a composite results in a more even distribution in blend morphology of the composite material. Use of a PVA compatibilizer, e.g., at levels of 5% or greater, with the TBP 220 increases the homogenous structure of the material when combining with pyrolysized organic matter.

The TBP is a polyester derived from natural means that enables biodegradable characteristics. In an embodiment, the TBP 220 is a polyhydroxyalkanoate (PHA). PHA is used due to a number of desirable mechanical properties suitable for the manufacturing of bioplastics, including, but not limited to, having a high percentage elongation, high tensile strength, and high melting point. In other embodiments, other TBP 220 materials may be used, such as materials classified as esters or polyesters, including polylactic acid (PLA), polycaprolactone (PCL), Poly(butyl acrylate) (PBA), polybutylene succinate (PBS), polybutylene adipate terephthalatep (PBAT), and polyhydroxybutyrate (PHB).

In an embodiment, the copolymer binder 210 and TBP 220 are shear mixed within a temperature range of 80-180 ° C. until the ingredients are fully blended. In an embodiment, step 110 is performed for 10-60 seconds in a shear mixer at an RPM within the range of 40-100 RPM. This allows the PVA compatibilizer to fully interact with the TBP 220, creating a fully blended resulting polymer mixture 225 as shown in FIG. 2.

At step 120, pyrolysized organic matter 230 and organic filler material 240 are added to the polymer mixture 225 to create a composite material 250.

The pyrolysized organic matter 230 is a material produced by processing organic input material using pyrolysis. In an embodiment, the input material includes post-consumer food waste. The pyrolysized organic matter 230 can either be homegeneous, i.e., sourced from a single type of waste, such as coffee grinds, or heterogeneous, i.e., comprising multiple source materials. The pyrolysis process creates pyrolysized organic matter 230 having a surface covered in micro-sized pores. In an embodiment, after the pyrolysized organic matter 230 is created, the particles are milled to a desired size of 200-800 micrometers, unless the particles are already within that size range. The pyrolysized organic matter 230 provides a nutrient source for plant and microbial life, where microorganisms can feed off the nutrients provided in the organic filler material, allowing for easy break down of the pyrolysized organic matter 230 and overall composite material.

In a further embodiment, the input material to the pyrolysis process is agricultural waste and plant matter. In such an embodiment, the output pyrolysized organic matter 230 is referred to as biochar.

In yet a further embodiment, the pyrolysized organic matter 230 is produced using alternative forms of the pyrolysis process, including via slow pyrolysis, intermediate pyrolysis, fast pyrolysis, microwave pyrolysis or other variations of the pyrolysis method. The variations of the pyrolysis process can produce pyrolysized organic matter 230 of varying quantities, qualities and with varying physical or chemical material performance that provides desirable characteristics for the manufacturing process or the intended use of the composite material 250.

The organic filler material 240 is an organic material having a particle size less than the micro-sized pores of the pyrolysized organic matter 230. In an embodiment, the organic filler material 240 is a starch, e.g., cornstarch having a particle size of 1-10 micrometers. In a further embodiment, the organic filler material 240 is wheatstarch, potato-starch, or a similar plant-based material having a particle size of 1-10 micrometers.

In an embodiment, the organic filler material 240 is cornstarch with a density of 0.54 g/cm³ and the pyrolysized organic matter 230 has a density of 1.34 g/cm³. However, the density of pyrolysized organic matter 230 sourced from post-consumer waste content can vary depending on the original source material.

Because the organic filler material 240 fills in the mirco-sized pores of the pyrolysized organic matter 230, the pyrolysized organic matter 230 can fully integrate with the polymer mixture 225 in step 120. In an embodiment, step 120 is performed by a shear mixer at the same temperature and RPM used in step 110. The resulting mixture produces a fully integrated composite material 250.

In an embodiment, the composite material 250 may further include additives depending on the desired resulting properties. These additives can include organic composites, copolymers, compatibilizers and reinforcing agents. For example, such additives can be incorporated into the composite material 250 when creating a composite material with specific concentration levels of the pyrolysized organic matter 230.

The additives or coatings may be incorporated into the composite material 250 to enhance thermal stabilization and flexural modulus for increased manufacturing processing and mechanical performance, and can, e.g., increase barrier properties needed to maintain compliance for packaging and other applications. For example, a coating with inert properties required for food packaging may be introduced into the composite material 250 when producing material for such use.

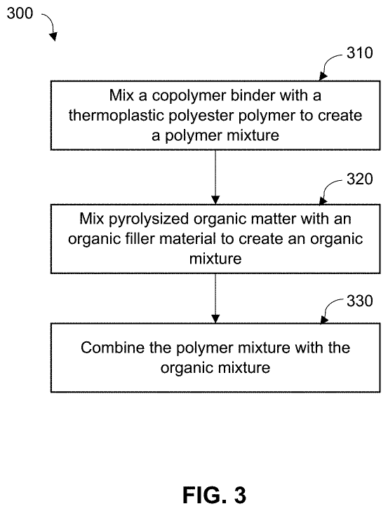

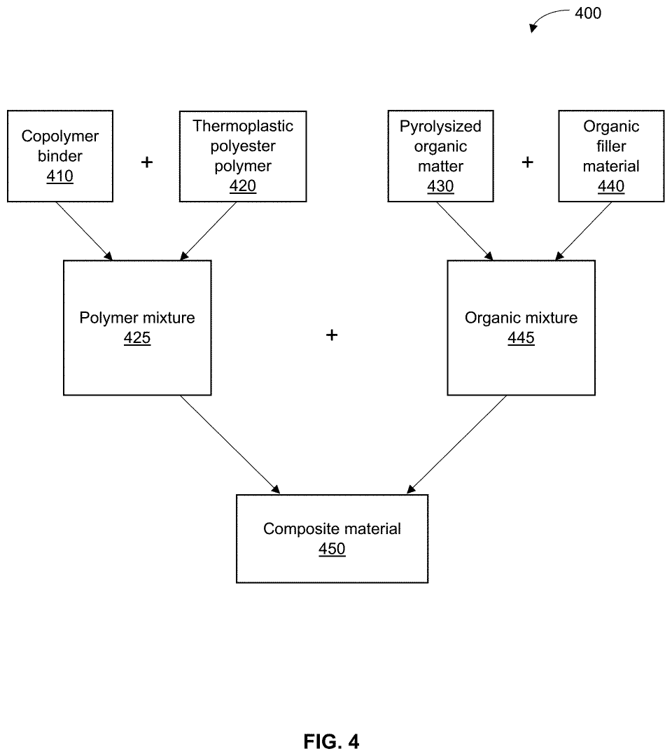

FIG. 3 is a flowchart of an additional embodiment for producing a composite material, and will be described in conjunction with FIG. 4, which is a schematic diagram 400 of the manufacturing process of the composite material in accordance with the method of FIG. 3.

At step 310, the copolymer binder 410 is mixed with the TBP 420 as described above in conjunction with step 110 of FIG. 1 to create the polymer mixture 425.

At step 320, the pyrolysized organic matter 430 is mixed with the organic filler material 440 to create an organic mixture 445. Where both the pyrolysized organic matter 430 and the organic filler material 440 are in powdered form, the resulting organic mixture 445 is in powdered form as well.

At step 330, the polymer mixture 425 is mixed with the organic mixture 445 to create the composite material 450. In an embodiment, step 330 is performed by a shear mixer at the same temperature and RPM used in step 310. The resulting mixture produces a fully integrated composite material 450.

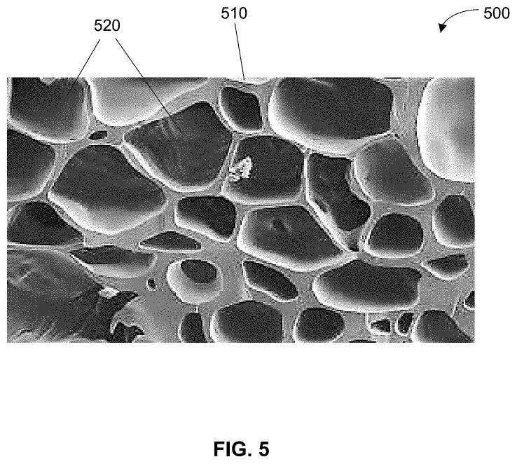

FIG. 5 is a screenshot of a microscopic image 500 of portion of a surface 510 of a particle of pyrolysized organic matter 230 and 430 in accordance with embodiments of the present disclosure. The surface 510 of the pyrolysized organic matter particles used in the present disclosure is covered in nanometric and micro-sized pores 520. In an embodiment, the pyrolysized organic matter particles are irregular in shape, as are the nanometric and micro-sized pores 520. The pyrolysized organic matter particles measure 200-800 micrometers and the size of the pores may range from the nanoscopic scale to 10 micrometers, depending on the host material and grain size of the pyrolysized organic matter.

The organic filler material 240 and 440 comprises particles having a particle size equal to or less than the size of pores 520 of the pyrolysized organic matter 230 and 430. In an embodiment, both the pores 520 and the organic filler material 240 and 440 particles have an average size range between 1-10 micrometers, allowing the pores 520 to be filled with the organic filler material 240 and 440. A resulting organic mixture can be fully integrated with a polymer mixture 225 and 425, as discussed with regard to the methods described in FIGS. 1 and 3.

When integrated with a granular filler material having particles with dimensions equal to or less than the size of the pores 520, the filler material fills the pores 520 causing the resulting material to have a smooth textured surface. In an embodiment, the resulting material is black in color with a matte black texture

In an embodiment, the resulting composite material 250 and 450 comprises 1-40 percentage by weight, or % by weight, of a copolymer binder; 10-60% by weight of TBP; 10-90% by weight of pyrolysized organic matter; and 5-60% by weight of starch. In a further embodiment, the composite material 250 and 450 comprises by weight at least 35% of the combined pyrolysized organic matter and the organic filler material.

In an embodiment, the copolymer binder of the composite material may be at least one of polyvinyl acetate (PVA) and ethylene; the TBP may be a polyhydroxyalkanoate (PHA); the organic filler material may be at least one of cornstarch, wheatstarch, and potato starch; and the pyrolysized organic matter may be post-consumer waste material, e.g., food waste.

The following are various non-limiting embodiments of the resulting composite material:

Embodiment A:
10% PVA compatibilizer
40% PHA
10% Pyrolysized organic matter
40% Organic filler material

Embodiment B:
10% PVA compatibilizer
35% PHA
15% Pyrolysized organic matter
40% Organic filler material

Embodiment C:
10% PVA compatibilizer
35% PHA
20% Pyrolysized organic matter
35% Organic filler material

The above described embodiments of the resulting composite material are examples only, and are non-limiting. Other percentages and compositions are within the scope of this disclosure as described herein.

The composite material 250 may be implemented in a variety of uses and applications, including, but not limited to, the following industries: packaging, automotive, agricultural, technology and electronics, consumer goods, waste and recycling, military and government and general industry. Additionally, the composite material 250 may be used within, but not limited to, the following processes: thermoforming and vacuum forming, injection molding, blown film extrusion and film blowing, blown injection molding, 3D printing, extrusion, lamination, compression molding, transfer molding, calendering, rotational molding, and pressure forming.

The foregoing detailed description of the present disclosure is to be understood as being in every respect illustrative and exemplary, but not restrictive, and the scope of the present disclosure provided herein is not to be determined solely from the detailed description, but rather from the claims as interpreted according to the full breadth and scope permitted by patent laws. It is to be understood that the embodiments shown and described herein are merely illustrative of the principles addressed by the present disclosure and that various modifications may be implemented by those skilled in the art without departing from the scope and spirit of the present disclosure. Those skilled in the art may implement various other feature combinations without departing from the scope and spirit of the present disclosure.

1. A method for manufacturing a composite material, comprising:
a) mixing a copolymer binder with a thermoplastic biopolyester polymer (TBP) at a mixing temperature of 80-180 ° C. to create a polymer mixture; and
b) mixing pyrolysized organic matter and an organic filler material with the polymer mixture to create the composite material.

2. The method of claim 1, wherein the mixing of the copolymer binder with the TBP is performed by a shear mixer.

3. The method of claim 2, wherein the shear mixer is operated at 40-100 revolutions per minute (RPM).

4. The method of claim 1, further comprising:
mixing the pyrolysized organic matter and the organic filler material to create an organic mixture prior to step b); and
wherein step b) comprises mixing the polymer mixture with the organic mixture.

5. The method of claim 1, wherein the pyrolysized organic matter is biochar.

6. The method of claim 1, wherein a source of the pyrolysized organic matter is post-consumer waste material. The method of claim 6, wherein the post-consumer waste material is food waste.

8. A method for manufacturing a composite material, comprising:
mixing a copolymer binder with a thermoplastic biopolyester polymer (TBP) at a mixing temperature of 80-280 ° C. to create a polymer mixture;
mixing pyrolysized organic matter and organic filler material to create an organic mixture; and mixing the polymer mixture with the organic mixture to create the composite material.

9. The method of claim 8, wherein a source of the pyrolysized organic matter is post-consumer waste material.

10. The method of claim 9, wherein the post-consumer waste material is food waste.

11. The method of claim 8, wherein the mixing of the copolymer binder with the TBP is performed by a shear mixer.

12. A composite material comprising:
a copolymer binder;
a thermoplastic biopolyester polymer (TBP);
pyrolysized organic matter; and
a organic filler material.

13. The composite material of claim 12, wherein the organic filler material comprises particles having a particle size equal to or less than a size of pores of the pyrolysized organic matter.

14. The composite material of claim 13, wherein an average size range of the pores of the pyrolysized organic matter is between 1-10 micrometers.

15. The composite material of claim 13, wherein an average size range of the organic filler material is between 1-10 micrometers.

16. The composite material of claim 12, wherein the composite material comprises by weight at least 35% of a combination of the pyrolysized organic matter and the organic filler material.

17. The composite material of claim 12, wherein the copolymer binder is at least one of polyvinyl acetate (PVA) and ethylene.

18. The composite material of claim 12, wherein the TBP at least one of: polyhydroxyalkanoate (PHA), polylactic acid (PLA), polycaprolactone (PCL), Poly(butyl acrylate) (PBA), polybutylene succinate (PBS), polybutylene adipate terephthalatep (PBAT), and polyhydroxybutyrate (PHB).

19. The composite material of claim 12, wherein the organic filler material is cornstarch.

20. The composite material of claim 12, wherein the pyrolysized organic matter is comprised of pyrolysized post-consumer waste material.

21. The composite material of claim 20, wherein the post-consumer waste material is food waste.
